(19) United States
(12) Patent Application Publication
(10) Pub. No.: US 2008/0014356 A1
(43) Pub. Date: Jan. 17, 2008

(54) Selective metal patterns using polyelect rolyte multilayer coatings

(76) Inventors: Ilsoon Lee, Okemos, MI (US); Troy R. Hendricks, East Lansing, MI (US)

Correspondence Address: HARNESS, DICKEY & PIERCE, P.L.C., P.O. BOX 828, BLOOMFIELD HILLS, MI, 48303, US

(21) Appl. No.: 11/818,994

(22) Filed: Jun. 15, 2007

Related U.S. Application Data
(60) Provisional application No. 60/814,705, filed on Jun. 16, 2006.

(51) Int. Cl. B05D 3/10

(52) U.S. Cl. 427/337

(57) ABSTRACT

Processes for creating versatile and selective metal patterns (such as copper and nickel) combine the use of PEM coatings, microcontact printing (MCP), and electroless deposition. MCP is used to pattern a charged catalyst (such as palladium and stannous ions) onto oppositely charged PEM coated substrates. The substrate is then placed into an electroless deposition bath where a metal selectively plates at the catalyzed regions.

### CROSS-REFERENCE TO RELATED APPLICATIONS

This application claims the benefit of U.S. Provisional Application No. 60/814,705, filed on Jun. 16, 2006. The disclosure of the above application is incorporated herein by reference.

### INTRODUCTION

The present disclosure relates to selective metal patterns applied to flexible substrates using polyelectrolyte multilayer (PEM) coatings.

Inexpensive metal patterning techniques with high selectivity have been the focus of current research in displays, radio frequency identification (RFID) transponders, sensors and other nano- and microelectronic device fabrication. Recently, many techniques have been developed to pattern metals on surfaces. Most of these techniques are surface-specific; when the substrates are changed these techniques fail to function properly. A more general and versatile approach to patterning metals is demanded for current and rapidly changing microelectronic applications.

Photolithography based top-down methods are the standard industrial patterning technique in microelectronics. However, this process is an expensive step in device fabrication, limits the functionality of substrates and other materials, and has an inability to work with curved substrates or the complex 3D structures needed for new electronic devices.

Microcontact printing (MCP), a soft lithographic patterning technique, combined with polyelectrolyte multilayer (PEM) coatings has been used to create functional three dimensional structures on plastic and other flexible substrates. Electroless deposition (ELD) is a metal plating technique that works on nano- or micrometer sized objects and can be used to selectively plate metal onto 2D and 3D structures.

Layer-by-layer (LBL) assembly of PEM coatings has been used to create ultra thin functional films on planar and 3D substrates. Incorporation of nano- and micron scale materials into multilayer assemblies alter surface, optical, mechanical or other properties which have material applications.

MCP is excellent for high throughput large area patterning with micron and submicron feature sizes. Poly(dimethylsiloxane) (PDMS) stamps were first used to create patterns of thiols on gold, and silanes on silica. Many other functional materials including m-dpoly(ethylene glycol)acid, polymers, polyelectrolyte aggregates and dendrimers have been patterned onto PEM coated substrates. LBL assembly on PDMS stamps and subsequent MCP has been used to create 3D structures of PEM and bionanocomposite arrays.

MCP and ELD have been used together to create selective metal patterns which are less expensive to produce than patterns created by conventional photolithography. By using MCP and ELD, numerous devices can be fabricated from a single photolithographic step; however devices produced solely from photolithography require the expensive photolithographic step to be repeated once per device.

Metal patterns have been created from the electroless deposition of copper, silver, gold, nickel and cobalt patterns, typically on silica substrates with palladium based catalysts. ELD catalysts do not strongly adhere to the substrate so an adhesion layer is required. To over come this obstacle a silane self-assembled monolayer (SAM) has been used as the adhesive layer. Substrates with patterned catalyst are created by directly stamping the catalyst or via an indirect method such as patterning the adhesion layer. Other ELD adhesion layers include phosphine-phosphonic acids titanium and poly(amidoamine)dendrimers. While these adhesion layers are effective, they are limited because they form substrate specific bonds that are not interchangeable like electrostatic charges.

LBL assembly of PEMs has been combined with ELD to make selective nickel patterns on glass and plastic substrates coated with PEMs. This method uses PEMs as the adhesion layer between the substrate and the deposited nickel. Ink-jet printing was used to pattern a polyelectrolyte ink onto a PEM surface resulting in plus/minus patterned regions. Then, directed self-assembly was used to selectively adsorb an ionic palladium catalyst onto the plus/minus patterned surface using electrostatic interactions. This approach is limited by the ink-jet printing resolution which is at best 20 μm. In addition, the directed self-assembly of charged catalysts onto functionally patterned surfaces often leads to poor selectivity of metal patterns on surfaces.

### SUMMARY

The drawbacks and limitations of the known technology have been overcome with the discovery and development of the present processes for creating versatile and selective metal patterns (such as copper and nickel) by combining PEM coatings, microcontact printing (MCP), and electroless deposition (ELD). MCP is used to pattern a charged catalyst (such as palladium, stannous ions, and the like) onto oppositely charged PEM coated substrates. PEMs, unlike silanes and thiols, can be stably coated onto virtually any substrate including hydrophobic polymer surfaces. This results in a highly selective, electrostatically bound charged catalyst ion complex on the PEM coated substrates. The substrate is then placed into an ELD bath where a metal, such as nickel or copper selectively plates only at the catalyzed regions. In various embodiments, the system, which involves PEMs as the stable adhesion layer, is more versatile, more economical, and works over a larger range of substrates than previous approaches. The combination of PEMs and MCP allows the control of 3D features on the micron and submicron scale. Stable and selective metal patterns can be created with nanometer dimensions on flexible substrates, which can result in lower fabrication costs to produce flexible display electronic circuits, sensors, RFID transponders, and other nano- or microelectronic devices.

In various embodiments, a catalyst is directly stamped onto a PEM. For example, a negatively charged palladium catalyst is stamped by MCP onto a positively charged PDAC surface.

In a directed self assembly type of process, positively charged dendrimers are printed onto a negative PEM surface, which is then exposed to a metal deposition catalyst, which is selectively adsorbed into the dendrimers.

In a dendrimer encapsulation process, a metal deposition (ELD) catalyst is first encapsulated into (positive) dendrimers, and the dendrimers containing the catalyst are stamped in a pattern onto a (negative) surface of the PEM.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic of the overall fabrication process to create selective copper patterns on PEM coated substrates followed by colloidal deposition.

FIG. 2 is reflected light optical micrographs of selective copper lines on PEM coated substrates. Parts a) and b) have glass substrates while c) is on a polystyrene substrate. d) Transmitted light optical micrograph of polystyrene particles deposited on the active unpatterned regions of the PEM surface next to the black copper lines. e) Electroless copper patterns on a PEM coated flexible polymer film substrate.

FIG. 3 is AFM images of a) a 20 μm×20 μm image of selective copper patterns and c) a 30 μm×30 μm image of multilevel structure created by stamping a substrate twice before electroless deposition.

### DESCRIPTION

The following description is merely exemplary in nature and is not intended to limit the present disclosure, application, or uses.

In various embodiments, a method of preparing a selective metal pattern on a substrate is provided. The method involves microcontact printing an ink composition onto a charged surface of a polyelectrolyte multilayer coated on the substrate, wherein the ink comprises an electroless deposition catalyst. Thereafter, the ink surface of the coated substrate is exposed to a solution that contains metal ions that are reduced upon reaction with the catalyst. In various embodiments, the charged surface is negative or positive, and the ink composition contains oppositely charged components, either positive or negative. In a non-limiting embodiment, the ink composition comprises negatively charged catalyst ions. In another embodiment, the ink composition comprises positively charged dendrimer particles. In various embodiments, the solution comprising metal ions is an electroless deposition bath that is optionally activated upon or after immersion of the ink coated substrate. Non-limiting examples of metal ions in the bath include nickel, copper, cobalt, silver, and gold. Suitable electroless catalysts are selected from those containing palladium or tin, by way of non-limiting example. The substrate is either flexible or rigid. In various embodiments, the method results in application of selective metal patterns on polyelectrolyte multilayer coatings on a substrate, which patterns are characterized by inter feature distances of less than 20 micrometers, or of less than 10 micrometers.

In another embodiment, a method of electroless plating onto a substrate in a selective pattern is provided. The method comprises first applying a polyelectrolyte multilayer to the substrate by successive exposure of the substrate to positive and negative polyelectrolytes. Separately, an ink composition is applied to a stamp that is fabricated in a selective pattern. Then the ink composition is transferred from the stamp to the substrate by contacting the stamp with the surface of the PEM on the substrate. Then, the inked surface is exposed to a bath that contains metal ions that plate in a pattern where the ink was applied to the surface. In various embodiments, the bath is an electroless plating bath and the ink composition comprises an electroless deposition catalyst. In various embodiments, the ink composition comprises negatively charged metal ions or positively charged nanoparticles that contain electroless deposition catalyst ions. In various embodiments, the nanoparticles are dendrimers, for example a fourth generation dendrimer. In a preferred embodiment, the ink comprises either palladium or tin salts and the electroless bath comprises nickel or copper. The stamp is preferably made of polydimethylsiloxane (PDMS). The selective pattern in the stamp that is transferred to the surface of the coated substrate is characterized in various embodiments by features of less than 20 micrometers in resolution, and illustratively less than 10 micrometers.

In another embodiment, a method of plating copper or nickel by electroless deposition onto a substrate is provided. The method involves applying a PEM to a surface of the substrate by alternatingly exposing the substrate to solutions of anionic and cationic polyelectrolytes, inking a PDMS stamp with a composition comprising an electroless deposition catalyst for copper or nickel, applying the ink to the surface of the PEM on the substrate by microcontact printing for a time sufficient to transfer the catalyst to the PEM surface, and exposing the inked PEM surface to a bath comprising nickel or copper ions, whereby the nickel or copper ions are reduced and deposit on the surface where catalyst was applied by contact with the stamp. In preferred embodiments, the catalyst contains a palladium or a tin salt. In various embodiments, the PEM is applied to the surface by applying ten or more alternating layers of polyanions and polycations to the substrate.

In another embodiment, a method of preparing a selective metal pattern on the substrate involves the selective assembly of the electroless deposition catalyst on a PEM surface. To illustrate, the method involves microcontact printing an ink composition onto a negatively charged surface of the PEM coating on the substrate wherein the ink comprises positively charged nanoparticles. Then the inked surface of the coated substrate is exposed to a solution comprising a metal-containing anion. The surface is then rinsed and exposed to a bath comprising metal ions that are reduced and plate on the surface where the charged nanoparticles were deposited. In an advantageous combination, the nanoparticles are dendrimers such as fourth generation PAMAM dendrimers, and the metal-containing anion contains palladium or tin, such as PdCl₄⁻². Advantageously, the anion is an electroless deposition catalyst for the metal ion and the bath.

Various aspects of the above embodiments and others are described further below. It is to be understood that features described of the various components of the invention can be combined in various ways to be used with any of the embodiments of the invention described herein. The description of the invention is applied for purposes of illustration. It is to be understood that the invention is not limited to the disclosed embodiments.

Films formed by electrostatic interactions between oppositely charged poly-ion species are called “polyelectrolyte multilayers” (PEM). PEM are prepared layer-by-layer by sequentially immersing a substrate, such as a silicon, glass, or plastic slide, in positively and then negatively charged polyelectrolyte solutions in a cyclic procedure. Suitable substrates are rigid (e.g. silicon, glass) or flexible (e.g. plastics such as PET). A wide range of negatively charged and positively charged polymers is suitable for making the layered materials. Suitable polymers are water soluble and sufficiently charged (by virtue of the chemical structure and/or the pH state of the solutions) to form a stable electrostatic assembly of electrically charged polymers. Sulfonated polymers such as sulfonated polystyrene (SPS), anethole sulfonic acid (PAS) and poly(vinyl sulfonic) acid (PVS) are commonly used as the negatively charged polyelectrolyte. Quaternary nitrogen-containing polymers such as poly (diallyidimethylammonium chloride) (PDAC) are commonly used as the positively charged electrolyte.

Assembly of the PEM's is well known; an exemplary process is illustrated by Decher in Science vol. 277, page 1232 (1997) the disclosure of which is incorporated by reference. The method can be conveniently automated with robots and the like. A polycation is first applied to a substrate followed by a rinse step. Then the substrate is dipped into a negatively charged polyelectrolyte solution for deposition of the polyanion, followed again by a rinse step. Alternatively, a polyanion is applied first and the polycation is applied to the polyanion. The procedure is repeated as desired until a number of layers is built up. A bilayer consists of a layer of polycation and a layer of polyanion. Thus for example, 10 bilayers contain 20 layers, while 10.5 bilayers contain 21 layers. With an integer number of bilayers, the top surface of the PEM has the same charge as the substrate. With a half bi-layer (e.g. 10.5 illustrated) the top surface of the PEM is oppositely charged to the substrate. Thus, PEM's can be built having either a negative or a positive charge “on top”.

Electroless deposition is a chemical reduction process based on the catalytic reduction of metal ions in an aqueous solution and subsequent deposition of reduced metal without electrical energy. The process is described for example in Mallory et al., Ed., Electroless Plating-Fundamentals and Applications, William Andrew Publishing/Noyes (1990), the disclosure of which is incorporated by reference. ELD catalysts activate the electroless deposition process on non-metallic surfaces such as the charged PEM surfaces used here. Catalysts are well known, and include stannous and palladium compounds, including the chlorides of each. A preferred catalyst is sodium tetrachloropalladate(II), Na₂[PdCl₄]. Electroless baths contain chemical agents that reduce the plating metal. Non-limiting examples of reducing agents include boron compounds. A non-limiting example of an electroless bath contains 2.0 g nickel sulfate, 1.0 g sodium citrate, 0.5 g lactic acid, 0.1 g DMAB (dimethylamine borane), in 50 mL of deionized water. The bath pH is adjusted to about 6.5, for example using 1.0M sodium hydroxide (NaOH).

In various embodiments, PEM surfaces that contain a pattern of catalyzed and uncatalyzed regions are exposed to an electroless deposition bath. Electroless deposition proceeds once the source of metal ions, reducing agent, and catalyst are brought together. Normally, the electroless deposition or plating is limited to those areas of the PEM surface that contain incorporated electroless deposition catalysts as described herein. The onset and rate of the electroless deposition process is controlled by varying or adjusting the pH of the electroless deposition bath, the temperature of the bath, and/or the presence and concentration of reducing agent. In one embodiment, the bath is adjusted to an appropriate pH and temperature while in contact with the PEM surface to be plated. Onset of the electroless deposition then occurs when reducing agent is added to the electroless deposition bath. Alternatively, onset can be controlled by adding metal ions to the electroless deposition bath once the pH, temperature, and reducing agents are suitable.

In various embodiments, the electroless deposition bath is provided in unactivated form and is activated upon or after contact with or immersion of the inked substrate in the bath. In general, an unactivated form of the electroless bath is missing a component needed for the reductive process to proceed. To illustrate, in the case of an electroless bath containing copper, the bath can be prepared without the reducing agent, and then the reducing agent can be added to “activate” the bath. In a further non-limiting illustration, for a nickel bath, it is possible to make the electroless bath composition containing the reducing agent and metal ions, but activate the bath by adjusting the pH. Experimentally, it is convenient to prepare large quantities of unactivated bath compositions and activate them as required to prepare the selective metal patterns described herein.

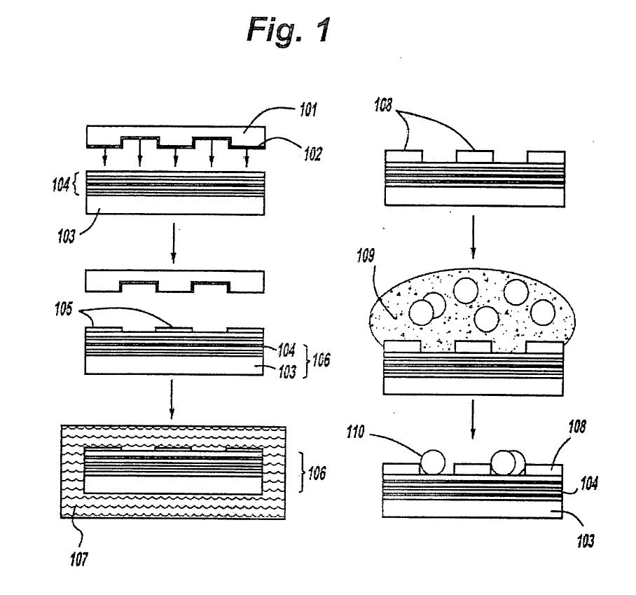

In catalyst stamping, the outer surface of a PEM is left positive (e.g., PDAC) and the negatively charged catalyst is transferred directly to the surface. FIG. 1 shows the overall scheme of the fabrication process. A stamp 101 inked with a catalyst 102 is brought into contact with the surface of a polyelectrolyte multilayer 104 coated on a substrate 103. The catalyst 102 on the stamp 101 is transferred to surface regions 105 of the PEM on the substrate. As shown, the inked coated substrate 106 is immersed in an electroless deposition bath 107. As a result, selective areas of metal 108 are deposited on the surface. In a subsequent step, the metal coated substrate is exposed to a colloidal solution containing charged particles 110. The charged particles self assemble on the surface of the polyelectrolyte multilayer 104 that is not covered by the deposited metal 108. With the addition of only a few polyelectrolyte bilayers the surface properties of a substrate can be completely changed to have either a positive or negative charge. In an exemplary embodiment, 10.5 bilayers of positively charged PDAC and negatively charged SPS, (PDAC/SPS)_{10.5}, are fabricated on glass and plastic substrates to create an outer surface with properties that are independent from the original substrate. The thickness of the PEM's varies as the number of bilayers. To illustrate, a PEM with 10.5 bilayers has a positively charged surface and a total thickness of ˜30 nm.

Catalyst is applied onto the PEM surface with micro-contact printing (MCP). Suitable stamps for use in MCP include those of polydimethylsiloxane (PDMS). In an illustrative example, an oxygen plasma treated PDMS stamp is soaked in a freshly prepared aqueous “ink” solution that contains negatively charged palladium ions. After soaking, the stamps are preferably blown dry with nitrogen and catalysts placed in conformal contact with the positively charged surface of the PEMs. The concentration of the ink is chosen for the desired performance. A suitable concentration of catalyst ions in the ink has been found to be 5 mM to 50 mM.

While the stamp is in contact with the surface, the negatively charged catalyst ions transfer to the positively charged surface via electrostatic interactions. After the stamp is removed, the patterned PEM surface is preferably rinsed with deionized water to remove the excess catalyst. After rinsing, the substrates contain alternating regions of positively charged polycation (e.g. PDAC) and negatively charged catalyst complexes. In a non-limiting example, 50 mM catalyst ions is directly stamped on the surface for 20 seconds of contact time. Then the inked substrate is immersed in an ELD bath for about 15 minutes.

In directed self assembly, an “ink” of positively charge dendrimers is used for stamping. An example is a generation 4 PAMAM dendrimer (4G PAMAM). To illustrate, a 0.1% solution of the dendrimer is swabbed onto the surface of a PDMS stamp with a cotton-tipped applicator. After drying, the stamp is brought into contact with the substrate for about 20 seconds (to apply dendrimer to the surface). The substrates are then washed with distilled water and immersed in a catalyst solution, e.g. 5 mM palladium catalyst. The immersion can be brief, for example about 10 seconds. The negative ions of the catalyst self assemble into the positively charged dendrimers to create catalyzed and uncatalyzed areas as before. After rinsing and drying, the substrates are placed in an electroless deposition bath.

In a non-limiting example, the stamp is inked with a 0.1% by weight solution of fourth generation dendrimer in water. The stamp is applied to the PEM surface for 20 seconds of contact time. Then the inked surface is immersed for 30 seconds in a 50 mM catalyst solution. Afterward, the catalyzed surface is immersed for 10 minutes in an ELD bath.

In dendrimer encapsulation, dendrimer encapsulated ions and nanoparticles are stamped directly on the PEM surface for example, using a 0.1% solution, with a contact time of for example, about 20 seconds. The samples (substrates) are then washed and place in an electroless deposition bath.

Dendrimer encapsulated palladium nanoparticles created by chemical reduction in solution are described here and in Chem. Mater. 15, 3873 (2003), the disclosure of which is incorporated by reference. To illustrate, fourth generation poly(amidoamine) (PAMAM) dendrimers—they are commercially available, e.g. from Aldrich—are placed into a 1 wt % aqueous solution. The pH of the solution is then reduced to 3.0 to protonate the exterior of the 64 surface amine groups using hydrochloric acid (HCl). Sodium tetrachloropalladate (II) (Na₂[PdCl₄]) is then added to make a 1:40 ratio (ions/dendrimer) with the dendrimers and left to mix for 30 minutes. During this time [PdCl₄]⁻ ions complex with the tertiary amines inside the dendrimer. The slow addition of dimethylamine borane (DMAB) in excess reduces the palladium ions to form nanoparticles. The solution is filtered to remove larger sized particles.

Transmission electron microscopy (TEM) samples are created by placing a drop of solution onto a carbon-coated Cu TEM grid and allowing the water to evaporate. TEM is used to determine the nanoparticle size and their distribution. Mass contrast TEM images are acquired and the diameter of forty randomly selected particles is measured. In a representative embodiment, the average nanoparticle size is 1.6±0.2 nm.

In various embodiments, the catalyst containing substrates are immersed in an electroless copper bath such as the optimized bath described in IBM J. Res. Develop. 37, 117 (1993), the disclosure of which is incorporated by reference. In a non-limiting example, a copper bath is heated to 50° C. (±2.0) and then a reducing agent such as dimethylamine borane (DMAB) is added to initiate the chemical reaction. The solution pH is reduced to 9.0 (±0.1) using a small amount of 1.0 M HCl. The catalyzed substrates are placed into the electroless copper bath where DMAB reduces the positive copper ions to zerovalent metallic copper, which selectively adsorbs onto the substrate in the regions of the surface where the catalyst is present. Metal deposition does not occur at the uncatalyzed regions of the surface, so the positively charged PDAC regions of the surface are metal free.

Additionally the methods are versatile because the chemical functional groups of the polyelectrolyte adhesion layer can be changed and other materials can easily be added to the multilayers to adapt the system.

### EXAMPLES

Experimental Details

Substrate Preparation—Coating of Substrates with PEM

To demonstrate the versatile and selective metal patterning process on virtually any surface type, hydrophilic glass and hydrophobic polystyrene substrates were selected. Glass microscope slides (Corning Glass Works, Corning, N.Y.) were sonicated with a Branson ultrasonic cleaner (Branson Ultrasonics Corporation, Danbury, Conn.) for 20 minutes in an Alconox (Alconox Inc., New York, N.Y.) solution followed by 10 minutes of sonication in water. The slides were then blown dry with nitrogen and plasma cleaned (Harrick Scientific Corporation, Broadway Ossining, N.Y.) with oxygen at ˜13.3 Pa for 10 minutes. Before use, polystyrene microscope slides (Nalge Nunc International, Rochester N.Y.) and flexible polyester transparency films (3M, St. Paul, Minn.) were plasma treated under the same conditions for 10 minutes. A Carl Zeiss slide stainer equipped with a custom-designed ultra sonication bath (Advanced Sonic Processing, Oxford, Conn.) was used to mechanically coat the substrates with PEMs. The glass and plastic slides were dipped into a 0.02 M solution of positively charged poly(diallyldimethylammonium chloride) (PDAC, Aldrich, Mw˜70,000) for 20 minutes followed by washing. Next the slides were dipped into a 0.02 M solution of negatively charged sulfonated poly(styrene), sodium salt (SPS, Aldrich, Mw˜150,000) followed by washing, which creates one bilayer. Both polyelectrolyte concentrations are based on the repeat unit of the polymer and each solution contained 0.1 M NaCl. The dipping process was repeated to form multilayers. Typically 10.5 bilayers of PDAC and SPS, written as (PDAC/SPS) 10.5 were used to coat the substrates to provide a cationic outer surface. The final half layer means that the outer surface is PDAC. If an anionic outer PEM surface is desired, the order of addition and/or the number of layers and bilayers is suitably adjusted. Deionized (DI) water from a Barnstead Nanopure Diamond (Barnstead International, Dubuque, Iowa) purification system with a resistance of >18.2 MΩ-cm was used for all aqueous solutions.

Microcontact Printing

A Sylgard 184 elastomer kit (Dow Corning, Midland, Mich.) was used to create poly(dimethylsiloxane) (PDMS) stamps which were used for MCP, (see Kumar et al., Langmuir 10, 1498 (1994), the disclosure of which is incorporated by reference). These stamps were created by pouring the prepolymer and initiator (10:1 mass ratio) on top of a fluorosilane treated patterned silicon master cured in an oven overnight at 60° C. The masters were prepared in the Microsystems Technology Lab at MIT and consisted of lines with widths from 1 to 10 μm. The silane treatment allowed for easy separation between the master and the cured PDMS. The stamps were cut to size and washed with soap and water before use. Before stamping, the PDMS stamps were oxygen plasma cleaned for one minute to make their surface hydrophilic. The PDMS stamps were soaked for 20 minutes in a freshly prepared 5 mM aqueous solution of the palladium catalyst, sodium tetrachloropalladate (II) (Na₂[PdCl₄], Strem Chemicals, Newburyport, Mass.). The stamps were removed from the ink solution, blown dry using nitrogen and brought into conformal contact with the PEM surface for five minutes. Then they were removed and the patterned samples were rinsed with flowing DI water. Since the catalyst ink solution has an unadjusted pH of 3.0, the rinse water pH was lowered to 3.0 by adding a small amount of 1.0 M hydrochloric acid (HCl).

Electroless Deposition Bath

Copper was selectively plated onto the previously deposited catalyst regions in a previously optimized electroless bath. The electroless bath contains 0.032 M cupric sulfate (J. T. Baker, Phillipsburg, N.J.), 0.040 M 1,5,8,12-tetraazadodecane (Fisher Scientific, Pittsburgh, Pa.), 0.300 M triethanolamine (Fisher Scientific), 0.067 M dimethylamine borane (DMAB, Aldrich Chemical, Milwaukee, Wis.) and 300 mg/mL 2,2′-dipyridyl (Aldrich) in DI water. The copper bath is used at a temperature of 50° C. (±2.0) and the pH is adjusted to 9.0 (±0.1) by adding a small amount of 1.0 M HCl.

Colloidal Adsorption

To show that the unpatterned surface is still functional (i.e. charged) and available for further modification or processing after metal deposition, colloidal particles are deposited onto the PDAC regions of the surface. A 0.5 wt. % colloidal solution of 4 μm carboxylated polystyrene particles (Interfacial Dynamics Corp., Portland, Oreg.) is gently dropped on the surface of a copper patterned glass slide and incubated for three hours. The particle coated substrates are then washed carefully with DI water and blown dry using nitrogen.

Quartz Crystal Microbalance Crystal Preparation

Gold coated quartz crystal microbalance (QCM) crystals (5 MHz, Maxtek, Inc., Santa Fe Springs, Calif.) were cleaned in fresh piranha solution (7:3 concentrated sulfuric acid; 30% hydrogen peroxide) for 20 seconds, rinsed with copious amount of water and blown dry with nitrogen. The crystals were then immersed into an ethanol solution containing 5 mM 16-mercaptohexadecanoic acid (Aldrich) for 30 minutes, copiously rinsed with ethanol and blown dry with nitrogen. Then multilayers, (PDAC/SPS)_{10.5}, were deposited onto the QCM crystal as described previously. A 30 second immersion into a freshly prepared 5 mM aqueous palladium catalyst solution followed by a DI water rinse was used to catalyze the crystals before electroless deposition.

Characterization

Optical micrograph images are taken using a Nikon Eclipse ME600 microscope equipped with a digital camera. Atomic force microscope (AFM) images are collected in tapping mode using a Nanoscope IV multimode scope from Digital Instruments. An environmental scanning electron microscope (SEM, model 2020, Electro Scan) equipped with a LaB₆ filament and operated at 20 kV with a water vapor environment in the sample chamber is used to obtain SEM images. Energy dispersive x-ray spectroscopy (EDXS) spectra are obtained using a Link ISIS system (Oxford Instruments). Metal plating rates were measured using a research QCM (Maxtek, Inc.) and accompanying computer program.

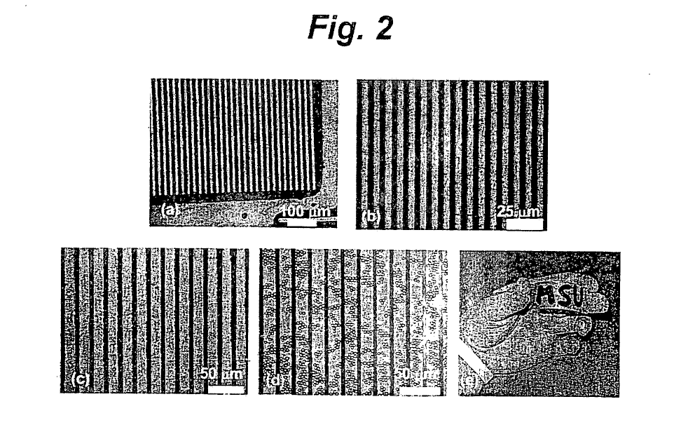

FIG. 2 shows optical micrograph images of the selective copper patterns. Reflected light optical microscope images of copper patterns on PEM coated glass and polystyrene substrates are shown in FIG. 2a-c. Plated copper was only found where the PDMS stamp was in contact with the positively charged polymer. It was possible to create highly selective results (i.e., nearly 100% selectivity) over areas as large as the entire stamp (˜1 cm²). Unlike our direct catalyst stamping on PEM coated substrates, the directed assembly of catalysts onto plus/minus (polycation/polyanion) micropatterned region by ‘polymer-on-polymer stamping’ (see Langmuir 18, 4505 (2002) and Langmuir 18, 2607 (2002) resulted in less selective copper patterns. We believe that this is because polycations and polyanions are integrated through the multilayers so that ‘plus’ and ‘minus’ patterned regions are not exclusively homogeneous at the molecular level on which the small charged catalysts cannot be completely directed to the oppositely charged regions. Only direct catalyst stamping onto PEMs can generate confined catalyst nano and micropatterns, which result in 100% selective metal patterns. In addition, the positively charged unpatterned PDAC surface was still active and could be modified further. To demonstrate this we deposited negatively charged polystyrene particles onto the unpatterned regions of the surface, FIG. 2d. Previously our group has shown that complete surface coverage of the particle monolayer is not expected from a simple drop coating. FIG. 2e shows an electroless copper pattern on a polyester transparency film that was coated with a PEM adhesion layer. The palladium catalyst was patterned on the surface using a cotton-tipped swab. This image demonstrates that flexible polyester transparency films can be patterned using our technique.

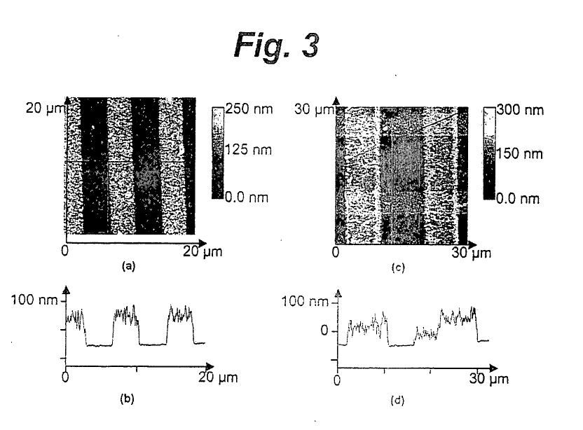

Atomic force microscopy (AFM) is performed to further analyze the sample topography. The AFM images in FIG. 3 again show that copper deposition scarcely occurs outside the patterned regions on the PEM surface. The sample of FIG. 3a has an average copper thickness of 107.6 nm (±4.3). The surface roughness of the deposited copper lines is 20 nm. FIG. 3c shows a sample that was stamped using two different stamps with a 90° separation in orientation and before immersion into a copper bath. This illustrates that complex 3D metal structures can be fabricated on PEM surfaces. Energy dispersive x-ray spectroscopy (EDXS) analysis of the sample confirms that copper is deposited in linear patterns on the PEM surface. More importantly, the spectrum shows that there is no detectable copper present on the polymer surface between the copper lines.

A QCM is used to study the kinetics of ELD on unpatterned homogeneously catalyzed or uncatalyzed surfaces. A carboxylic acid terminated thiol is used to create a SAM on the gold coated quartz crystals. This results in a negatively charged outer surface. (PDAC/SPS)_{10.5} bilayers are deposited on the thiol to create uncatalyzed QCM crystals. The crystals are catalyzed by immersion into an aqueous palladium catalyst solution followed by rinsing with DI water (pH ˜3.0). The QCM crystal and the copper bath are simultaneously heated to 50° C. The copper bath is then activated and the pH was adjusted. The warm QCM crystal is placed into the activated copper bath. A change in copper thickness is calculated from the change in frequency of the QCM crystal using the QCM computer software. The QCM results are plotted for a catalyzed and uncatalyzed PDAC surface. The different plating rates shown in the plot verify the high selectivity of the electroless copper bath. Copper uniformly plates on the catalyzed surface and does not deposit on the uncatalyzed PDAC surface. An initial non-linear plating rate of the catalyzed sample is caused by the increasing area available for copper deposition. After seven minutes, linear growth is observed with an average plating rate of 26.8 nm/min. This plating rate agrees well with a previously reported rate of 23.3 nm/min for the same copper bath under similar conditions. We are able to create copper thicknesses of up to 300 nm using only electroless deposition.

In conclusion, a novel versatile process incorporating PEMs, MCP and ELD has been utilized to create copper patterns with excellent selectivity on top of PEM coated substrates. MCP and ELD together reduce fabrication costs of metal patterns and structures compared to conventional photolithographic techniques. The ability of PEMs to coat any surface allows bendable plastic to be used and can reduce the cost of materials in future electronic devices such as bendable displays, sensors, and RFID transponders. The combination of layer-by-layer assembly with MCP gives nanoscale control of the feature dimensions. The copper free PEM surface is still functional and can be modified to fabricate 3D metal structures or even patterns composed of two or more metals.

This work was funded by the Intramural Research Grant Program, the Center for Fundamental Materials Research, and the Michigan Technology Tri-Corridor funds. The analytical support provided through the Surface Characterization Facility in the Composite Materials and Structures Center is gratefully acknowledged.

We claim:

1. A method of preparing a selective metal pattern on a substrate, the method comprising:
microcontact printing an ink composition onto a charged surface of a polyelectrolyte multilayer coated on the substrate, wherein the ink composition comprises an electroless deposition catalyst; and
exposing the inked surface of the coated substrate to a solution comprising metal ions that are reduced upon reaction with the catalyst.

2. A method according to claim 1, wherein the charged surface is negative.

3. A method according to claim 1, wherein the charged surface is positive.

4. A method according to claim 1, wherein the ink composition comprises negatively charged catalyst ions.

5. A method according to claim 1, wherein the ink composition comprises positively charged dendrimers.

6. A method according to claim 1, wherein the metal ions comprise nickel or copper.

7. A method according to claim 1, wherein the electroless deposition catalyst comprises palladium or tin.

8. A method according to claim 1, wherein the substrate is flexible.

9. A method according to claim 1, wherein the substrate is rigid.

10. A method according to claim 1, wherein the metal pattern is characterized by inter-feature distances of 20 micrometers or less.

11. A method of electroless plating of a metal onto a substrate in a selective pattern, the method comprising:
applying a polyelectrolyte membrane (PEM) to the substrate by successive exposure of the substrate to positive and negative polyelectrolytes;
applying an ink composition to a stamp fabricated in the selective pattern;
transferring the ink composition to the substrate by contacting the stamp with the surface of the PEM on the substrate; and
exposing the inked surface to a bath comprising metal ions that plate in a pattern where the ink was applied to the surface.

12. A method according to claim 11, wherein the bath is an electroless plating bath and the ink composition comprises an electroless deposition catalyst.

13. A method according to claim 11, wherein the ink comprises negatively charged metal ions.

14. A method according to claim 11, wherein the ink comprises positively charged nanoparticles that comprise electroless deposition catalyst ions.

15. A method according to claim 14, wherein the nanoparticles comprise dendrimers.

16. A method according to claim 11, wherein the ink comprises palladium or tin and the bath comprises nickel or copper.

17. A method according to claim 11, wherein the stamp is made of polydimethylsiloxanes (PDMS).

18. A method according to claim 11, wherein the pattern is characterized by features of less than 20 micrometers in resolution.

19. A method of plating copper or nickel by electroless deposition onto a substrate, the method comprising:
applying a PEM to a surface of the substrate by alternatingly exposing the substrate to solutions of anionic and cationic polyelectrolyte;
inking a PDMS stamp with a composition comprising an electroless deposition catalyst for copper or nickel;
applying the ink to the surface of the PEM on the substrate by microcontact printing for a time sufficient to transfer catalyst to the PEM surface; and
exposing the inked PEM surface to a bath comprising nickel or copper ions, whereby the nickel or copper ions are reduced and deposit on the surface where catalyst was applied.

20. A method according to claim 19, wherein the catalyst comprises palladium or tin.

21. A method according to claim 19, comprising applying ten or more alternating layers of polyanions and polycation to the substrate to make the PEM.

22. A method according to claim 19, wherein the bath comprises copper ions.

23. A method according to claim 19, wherein the bath comprises nickel ions.

24. A method of preparing a selective metal pattern on a substrate, comprising
microcontact printing an ink composition onto a negatively charged surface of a PEM coated on the substrate wherein the ink comprises a positively charged nanoparticles;
exposing the inked surface to a solution comprising a metal containing anion;
rinsing the surface; and
exposing the rinsed surface to a bath comprising metal ions that are reduced and plate on the surface where the charged nanoparticles were deposited.

25. A method according to claim 24, wherein the nanoparticles are dendrimers.

26. A method according to claim 25, wherein the dendrimers are fourth generation PAMAM dendrimers.

27. A method according to claim 24, wherein the metal containing anion comprises palladium or tin.

28. A method according to claim 24, wherein the metal ions in the bath comprise nickel or copper.

29. A method according to claim 24, wherein the metal containing anion is an electroless deposition catalyst for the metal ion.
